(19) United States
(12) Patent Application Publication
(10) Pub. No.: US 2014/0223505 A1
(43) Pub. Date: Aug. 7, 2014

(54) METHOD AND APPARATUS FOR CONTROL OF ELECTRONIC MEDIA

(71) Applicants: Mihal Lazaridis, Waterloo (CA); David Smith, Georgetown (CA); George Staikos, Georgetown (CA)

(72) Inventors: Mihal Lazaridis, Waterloo (CA); David Smith, Georgetown (CA); George Staikos, Georgetown (CA)

(73) Assignee: BlackBerry Limited, Waterloo, ON (CA)

(21) Appl. No.: 14/343,195

(22) PCT Filed: Sep. 9, 2011
(86) PCT No.: PCT/CA2011/050545

§ 371 Date: Mar. 6, 2014

(51) Int. Cl. H04N 21/462; H04N 21/414; H04N 21/222

(52) U.S. Cl. CPC H04N 21/462; H04N 21/222; H04N 21/414
USPC 725/116

(57) ABSTRACT

Devices and methods are provided for managing media content across multiple communication systems and related devices. In various embodiments, a client node detects a first media content stream being presented. The client node then generates and provides a content stream identification request message to the control system. In response, the control system provides content identification data associated with the first content stream to the client node, which processes it to generate and provide a content request message to a control server node.

### BACKGROUND OF THE INVENTION

1. Field of the Invention

The present invention is directed in general to communications systems and methods for operating same. In one aspect, the present invention relates to devices and methods for managing media content across multiple communication systems and related devices.

2. Description of the Related Art

The term “electronic media” refers to a fairly diverse set of techniques for delivering information and entertainment. These techniques include general radio and television broadcasting, specialized radio and television broadcasting such as cable and satellite radio and television, motion picture distribution to live theatres, and others. By the year 2010, many economic and technical substitutes had exhibited a significant degree of adoption, such as Internet radio broadcasts and streaming video. Currently, the state of the art of communication systems has also sufficiently advanced to enable multiple heterogeneous sources and delivery systems of electronic media and other information to interoperate in ways that may increase the utility value to the consumer of such media.

An example of such interoperation is a “mash-up” of information on a mobile computing device. The mash-up combines information and media from multiple sources to produce a synergistic representation of the combined elements. As an example, geographical map graphics may be combined with location coordinate data and a database of items related to the current location of the device's user. To further the example, the user might elect to view the location of restaurants, stores or homes for sale that are proximate to the user's location.

Likewise, the global deployment and general availability of wide area wireless voice and data systems to business users and consumers alike in developed countries has further enabled the innovation of electronic media control and presentation. However, challenges still exist. For example, one known issue is how to enable user interaction between the provider of electronic media content and the consumer in a proactive manner, using multiple communication devices and networks that are all readily available to one another, but generally not interconnected to one another either logical or physically.

### BRIEF DESCRIPTION OF THE DRAWINGS

The present invention may be understood, and its numerous objects, features and advantages obtained, when the following detailed description is considered in conjunction with the following drawings, in which:

FIG. 1 depicts an exemplary system in which the present invention may be implemented:

FIG. 2 is a simplified block diagram of an exemplary client node comprising a digital signal processor (DSP):

FIG. 3 is a simplified block diagram of a software environment that may be implemented by a DSP:

FIG. 4 is a simplified block diagram of a content management system: and

FIG. 5 is a generalized signal process flow for managing media content across multiple communication systems and related devices.

### DETAILED DESCRIPTION

Devices and methods are provided for managing media content (e.g., analog or digital media content) across multiple communication systems and related devices. In various embodiments, a client node detects a first media content stream being presented. The client node then generates and provides a content stream identification request message to the media content receiver providing the first media content stream being displayed. In response the media content receiver provides content identification data associated with the first content stream to the client node, which processes it to generate and provide a content request message to a control server node. In various embodiment, geographic information may be used to further identify the first media content stream.

Various illustrative embodiments of the present invention will now be described in detail with reference to the accompanying figures. While various details are set forth in the following description, it will be appreciated that the present invention may be practiced without these specific details, and that numerous implementation-specific decisions may be made to the invention described herein to achieve the inventor's specific goals, such as compliance with process technology or design-related constraints, which will vary from one implementation to another. While such a development effort might be complex and time-consuming, it would nevertheless be a routine undertaking for those of skill in the art having the benefit of this disclosure. For example, selected aspects are shown in block diagram and flowchart form, rather than in detail, in order to avoid limiting or obscuring the present invention. In addition, some portions of the detailed descriptions provided herein are presented in terms of algorithms or operations on data within a computer memory. Such descriptions and representations are used by those skilled in the art to describe and convey the substance of their work to others skilled in the art.

As used herein, the terms “component,” system and the like are intended to refer to a computer-related entity, either hardware, software, a combination of hardware and software, or software in execution. For example, a component may be, but is not limited to being, a processor, a process running on a processor, an object, an executable, a thread of execution, a program, or a computer. By way of illustration, both an application running on a computer and the computer itself can be a component. One or more components may reside within a process or thread of execution and a component may be localized on one computer or distributed between two or more computers.

As likewise used herein, the term “node” broadly refers to a connection point, such as a redistribution point or a communication endpoint, of a communication environment, such as a network. Accordingly, such nodes refer to an active electronic device capable of sending, receiving, or forwarding information over a communications channel. Examples of such nodes include data circuit-terminating equipment (DCE), such as a modem, hub, bridge or switch, and data terminal equipment (DTE), such as a handset, a printer or a host computer (e.g., a router, workstation or server). Examples of local area network (LAN) or wide area network (WAN) nodes include computers, packet switches, cable moderns, Data Subscriber Line (DSL) modems, and wireless LAN (WLAN) access points. Examples of Internet or Intranet nodes include host computers identified by an Internet Protocol (IP) address, bridges and WLAN access points. Likewise, examples of nodes in cellular communication include base stations, relays, base station controllers, home location registers, Gateway GPRS Support Nodes (GGSN), and Serving GPRS Support Nodes (SGSN).

Other examples of nodes include client nodes, server nodes, peer nodes and access nodes. As used herein, a client node may refer to wireless devices such as mobile telephones, smart phones, personal digital assistants (PDAs), handheld devices, portable computers, tablet computers, and similar devices or other user equipment (UE) that has telecommunications capabilities. Such client nodes may likewise refer to a mobile, wireless device, or conversely, to devices that have similar capabilities that are not generally transportable, such as desktop computers, set-top boxes, or sensors. Likewise, a server node, as used herein, refers to an information processing device (e.g., a host computer), or series of information processing devices, that perform information processing requests submitted by other nodes. As likewise used herein, a peer node may sometimes serve as client node, and at other times, a server node. In a peer-to-peer or overlay network, a node that actively routes data for other networked devices as well as itself may be referred to as a supernode.

An access node, as used herein, refers to a node that provides a client node access to a communication environment. Examples of access nodes include cellular network base stations and wireless broadband (e.g., WiFi, WiMAX, etc) access points, which provide corresponding cell and WLAN coverage areas. As used herein, a macrocell is used to generally describe a traditional cellular network cell coverage area. Such macrocells are typically found in rural areas, along highways, or in less populated areas. As likewise used herein, a microcell refers to a cellular network cell with a smaller coverage area than that of a macrocell. Such micro cells are typically used in a densely populated urban area. Likewise, as used herein, a picocell refers to a cellular network coverage area that is less than that of a microcell. An example of the coverage area of a picocell may be a large office, a shopping mall, or a train station. A femtocell, as used herein, currently refers to the smallest commonly accepted area of cellular network coverage. As an example, the coverage area of a femtocell is sufficient for homes or small offices.

In general, a coverage area of less than two kilometers typically corresponds to a microcell, 200 meters or less for a picocell, and on the order of 10 meters for a femtocell. As likewise used herein, a client node communicating with an access node associated with a macrocell is referred to as a “macrocell.” Likewise, a client node communicating with an access node associated with a microcell, picocell, or femtocell is respectively referred to as a “microcell client,” “picocell client,” or “femtocell clinet.”

The term “article of manufacture” (or alternatively, “computer program product”) as used herein is intended to encompass a computer program accessible from any computer-readable device or media. For example, computer readable media can include but are not limited to magnetic storage devices (e.g., hard disk, floppy disk, magnetic strips, etc.), optical disks such as a compact disk (CD) or digital versatile disk (DVD), smart cards, and flash memory devices (e.g., card, stick, etc.).

The word “exemplary” is used herein to mean serving as an example, instance, or illustration. Any aspect or design described herein as “exemplary” is not necessarily to be construed as preferred or advantageous over other aspects or designs. Those of skill in the art will recognize many modifications may be made to this configuration without departing from the scope, spirit or intent of the claimed subject matter. Furthermore, the disclosed subject matter may be implemented as a system, method, apparatus, or article of manufacture using standard programming and engineering techniques to produce software, firmware, hardware, or any combination thereof to control a computer or processor-based device to implement aspects detailed herein.

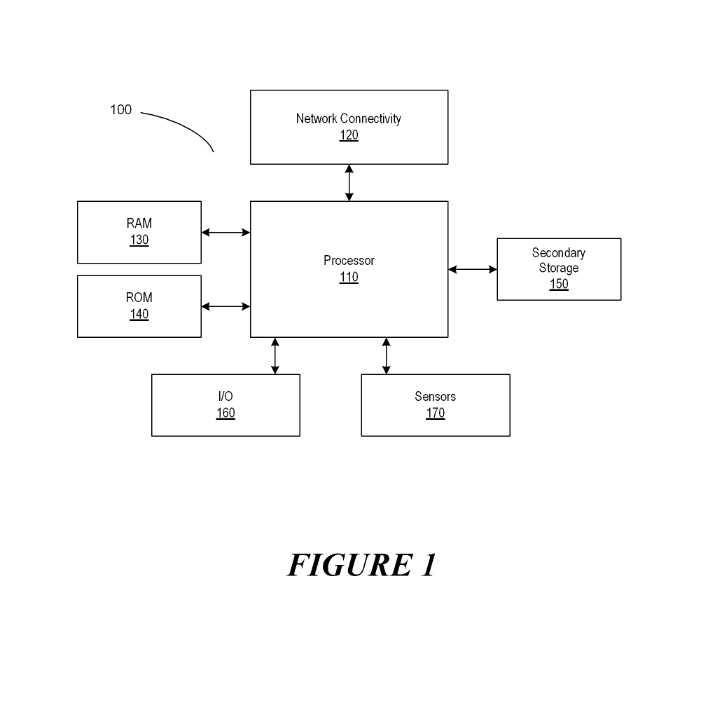

FIG. 1 illustrates an example of a system 100 suitable for implementing one or more embodiments disclosed herein. In various embodiments, the system 100 comprises a processor 110, which may be referred to as a central processor unit (CPU) or digital signal processor (DSP), network connectivity interfaces 120, random access memory (RAM) 130, read only memory (ROM) 140, secondary storage 150, and input/output (I/O) devices 160. In some embodiments, some of these components may not be present or may be combined in various combinations with one another or with other components not shown. These components may be located in a single physical entity or in more than one physical entity. Any actions described herein as being taken by the processor 110 might be taken by the processor 110 alone or by the processor 110 in conjunction with one or more components shown or not shown in FIG. 1.

The processor 110 executes instructions, codes, computer programs, or scripts that it might access from the network connectivity interfaces 120, RAM 130, or ROM 140. While only one processor 110 is shown, multiple processors may be present. Thus, while instructions may be discussed as being executed by a processor 110, the instructions may be executed simultaneously, serially, or otherwise by one or multiple processors 110 implemented as one or more CPU chips.

In various embodiments, the network connectivity interfaces 120 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, long term evolution (LTE) radio transceiver devices, worldwide interoperability for microwave access (WiMAX) devices, and/or other well-known interfaces for connecting to networks, including Personal Area Networks (PANs) such as Bluetooth. These network connectivity interfaces 120 may enable the processor 110 to communicate with the Internet or one or more telecommunications networks or other networks from which the processor 110 might receive information or to which the processor 110 might output information.

The network connectivity interfaces 120 may also be capable of transmitting or receiving data wirelessly in the form of electromagnetic waves, such as radio frequency signals or microwave frequency signals. Information transmitted or received by the network connectivity interfaces 120 may include data that has been processed by the processor 110 or instructions that are to be executed by processor 110. The data may be ordered according to different sequences as may be desirable for either processing or generating the data or transmitting or receiving the data.

In various embodiments, the RAM 130 may be used to store volatile data and instructions that are executed by the processor 110. The ROM 140 shown in FIG. 1 may likewise be used to store instructions and data that is read during execution of the instructions. The secondary storage 150 is typically comprised of one or more disk drives or tape drives and may be used for non-volatile storage of data or as an overflow data storage device if RAM 130 is not large enough to hold all working data. Secondary storage 150 may likewise be used to store programs that are loaded into RAM 130 when such programs are selected for execution. The I/O devices 160 may include liquid crystal displays (LCDs), Light Emitting Diode (LED) displays, Organic Light Emitting Diode (OLED) displays, projectors, televisions, touch screen displays, keyboards, keypads, switches, dials, mice, track balls, voice recognizers, card readers, paper tape readers, printers, video monitors, microphones or other well-known input/output devices.

Also, in various embodiments, the system may include one or more sensors 170 coupled to the processor 110. The sensors may include a microphone, a camera, a global positioning system (GPS) type device as well as other types of sensors that can detect analog or digital information.

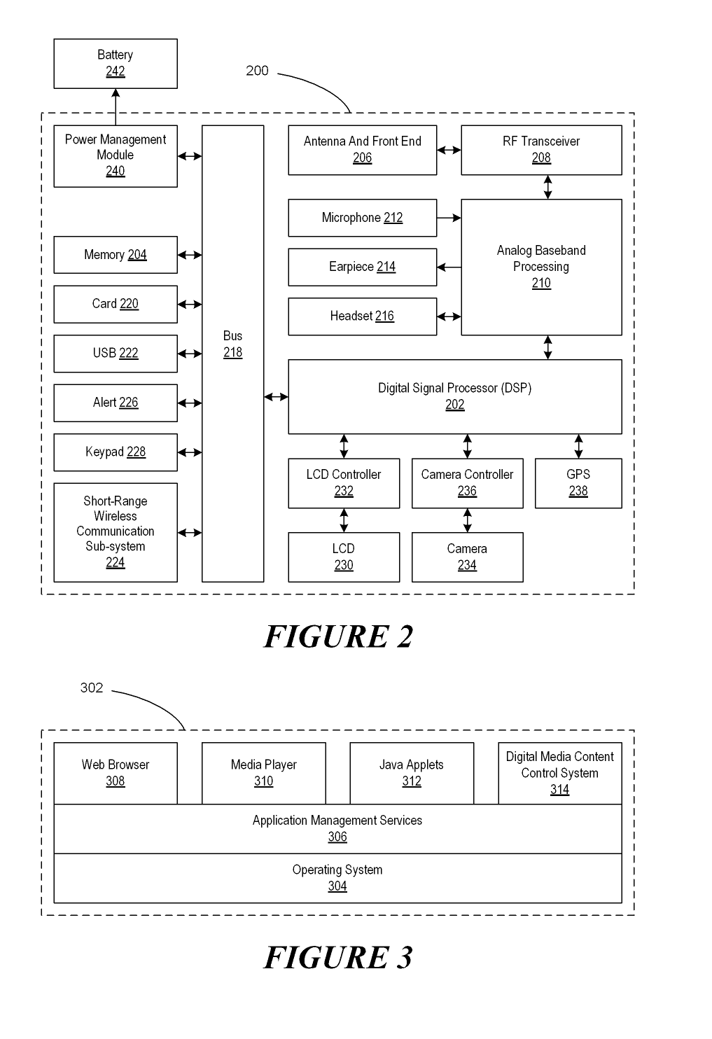

FIG. 2 depicts a block diagram of an exemplary client node as implemented with a digital signal processor (DSP) in accordance with an embodiment of the invention. While various components of a client node are depicted, various embodiments of the client node may include a subset of the listed components or additional components not listed. As shown in FIG. 2, the client node 200 includes a DSP 202 and a memory 204. As shown, the client node 200 may further include an antenna and front end unit 206, a radio frequency (RF) transceiver 208, an analog baseband processing unit 210, a microphone 212, an earpiece speaker 214, a headset port 216, a bus 218, such as a system bus or an input/output (I/O) interface bus, a removable memory card 220, a universal serial bus (USB) port 222, a short range wireless communication sub-system 224, an alert 226, a keypad 228, a liquid crystal display (LCD) 230, which may include a touch sensitive surface, an LCD controller 232, a charge-coupled device (CCD) camera 234, a camera controller 236, and a global positioning system (GPS) sensor 238, and a power management module 240 operably coupled to a power storage unit, such as a battery 242. In various embodiments, the client node 200 may include another kind of display that does not provide a touch sensitive screen. In one embodiment, the DSP 202 communicates directly with the memory 204 without passing through the input/output interface 218.

In various embodiments, the DSP 202 or some other form of controller or central processing unit (CPU) operates to control the various components of the client node 200 in accordance with embedded software or firmware stored in memory 204 or stored in memory contained within the DSP 202 itself In addition to the embedded software or firmware, the DSP 202 may execute other applications stored in the memory 204 or made available via information carrier media such as portable data storage media like the removable memory card 220 or via wired or wireless network communications. The application software may comprise a compiled set of machine-readable instructions that configure the DSP 202 to provide the desired functionality, or the application software may be high-level software instructions to be processed by an interpreter or compiler to indirectly configure the DSP 202.

The antenna and front end unit 206 may be provided to convert between wireless signals and electrical signals, enabling the client node 200 to send and receive information from a cellular network or some other available wireless communications network or from a peer client node 200. In an embodiment, the antenna and front end unit 106 may include multiple antennas to support beam forming and/or multiple input multiple output (MIMO) operations. As is known to those skilled in the art, MIMO operations may provide spatial diversity which can be used to overcome difficult channel conditions or to increase channel throughput. Likewise, the antenna and front end unit 206 may include antenna tuning or impedance matching components, RF power amplifiers, or low noise amplifiers.

In various embodiments, the RF transceiver 208 provides frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions. For the purposes of clarity, the description here separates the description of this signal processing from the RF and/or radio stage and conceptually allocates that signal processing to the analog baseband processing unit 210 or the DSP 202 or other central processing unit. In some embodiments, the RF Transceiver 108, portions of the Antenna and Front End 206, and the analog base band processing unit 210 may be combined in one or more processing units and/or application specific integrated circuits (ASICs).

The analog baseband processing unit 210 may provide various analog processing of inputs and outputs, for example analog processing of inputs from the microphone 212 and the headset 216 and outputs to the earpiece 214 and the headset 216. To that end, the analog baseband processing unit 210 may have ports for connecting to the built-in microphone 212 and the earpiece speaker 214 that enable the client node 200 to be used as a cell phone. The analog baseband processing unit 210 may further include a port for connecting to a headset or other hands-free microphone and speaker configuration. The analog baseband processing unit 210 may provide digital-to-analog conversion in one signal direction and analog-to-digital conversion in the opposing signal direction. In various embodiments, at least some of the functionality of the analog baseband processing unit 210 may be provided by digital processing components, for example by the DSP 202 or by other central processing units.

The DSP 202 may perform modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions associated with wireless communications. In an embodiment, for example in a code division multiple access (CDMA) technology application, for a transmitter function the DSP 202 may perform modulation, coding, interleaving, and spreading, and for a receiver function the DSP 202 may perform despreading, deinterleaving, decoding, and demodulation. In another embodiment, for example in an orthogonal frequency division multiplex access (OFDMA) technology application, for the transmitter function the DSP 202 may perform modulation, coding, interleaving, inverse fast Fourier transforming, and cyclic prefix appending, and for a receiver function the DSP 202 may perform cyclic prefix removal, fast Fourier transforming, deinterleaving, decoding, and demodulation. In other wireless technology applications, yet other signal processing functions and combinations of signal processing functions may be performed by the DSP 202.

The DSP 202 may communicate with a wireless network via the analog baseband processing unit 210. In some embodiments, the communication may provide Internet connectivity, enabling a user to gain access to content on the Internet and to send and receive e-mail or text messages. The input/output interface 218 interconnects the DSP 202 and various memories and interfaces. The memory 204 and the removable memory card 220 may provide software and data to configure the operation of the DSP 202. Among the interfaces may be the USB interface 222 and the short range wireless communication sub-system 224. The USB interface 222 may be used to charge the client node 200 and may also enable the client node 200 to function as a peripheral device to exchange information with a personal computer or other computer system. The short range wireless communication sub-system 224 may include an infrared port, a Bluetooth interface, an IEEE 802.11 compliant wireless interface, or any other short range wireless communication sub-system, which may enable the client node 200 to communicate wirelessly with other nearby client nodes and access nodes.

The input/output interface 218 may further connect the DSP 202 to the alert 226 that, when triggered, causes the client node 200 to provide a notice to the user, for example, by ringing, playing a melody, or vibrating. The alert 226 may serve as a mechanism for alerting the user to any of various events such as an incoming call, a new text message, and an appointment reminder by silently vibrating, or by playing a specific pre-assigned melody for a particular caller.

The keypad 228 couples to the DSP 202 via the I/O interface 218 to provide one mechanism for the user to make selections, enter information, and otherwise provide input to the client node 200. The keyboard 228 may be a full or reduced alphanumeric keyboard such as QWERTY, Dvorak, AZERTY and sequential types, or a traditional numeric keypad with alphabet letters associated with a telephone keypad. The input keys may likewise include a trackwheel, an exit or escape key, a trackball, and other navigational or functional keys, which may be inwardly depressed to provide further input function. Another input mechanism may be the LCD 230, which may include touch screen capability and also display text and/or graphics to the user. The LCD controller 232 couples the DSP 202 to the LCD 230.

The camera 234, if equipped, enables the client node 200 to take digital pictures. The DSP 202 communicates with the camera 234 via the camera controller 236. In another embodiment, a camera operating according to a technology other than Charge Coupled Device cameras may be employed. The GPS sensor 238 is coupled to the DSP 202 to decode global positioning system signals or other navigational signals, thereby enabling the client node 200 to determine its position. Various other peripherals may also be included to provide additional functions, such as radio and television reception.

FIG. 3 illustrates a software environment 302 that may be implemented by a digital signal processor (DSP). In this embodiment, the DSP 202 shown in FIG. 2 executes an operating system 304, which provides a platform from which the rest of the software operates. The operating system 304 likewise provides the client node 200 hardware with standardized interfaces (e.g., drivers) that are accessible to application software. The operating system 304 likewise comprises application management services (AMS) 306 that transfer control between applications running on the client node 200. Also shown in FIG. 3 are a web browser application 308, a media player application 310, and Java applets 312. The web browser application 308 configures the client node 200 to operate as a web browser, allowing a user to enter information into forms and select links to retrieve and view web pages. The media player application 310 configures the client node 200 to retrieve and play audio or audiovisual media. The Java applets 312 configure the client node 200 to provide games, utilities, and other functionality. In various embodiments, the media content control system 314 provides functionality described in greater detail herein. In various embodiments, the client node 200, the wireless network nodes ‘A’ 210 through ‘n’ 216, and the server node 224 shown in FIG. 2 may likewise include a processing component that is capable of executing instructions related to the actions described above.

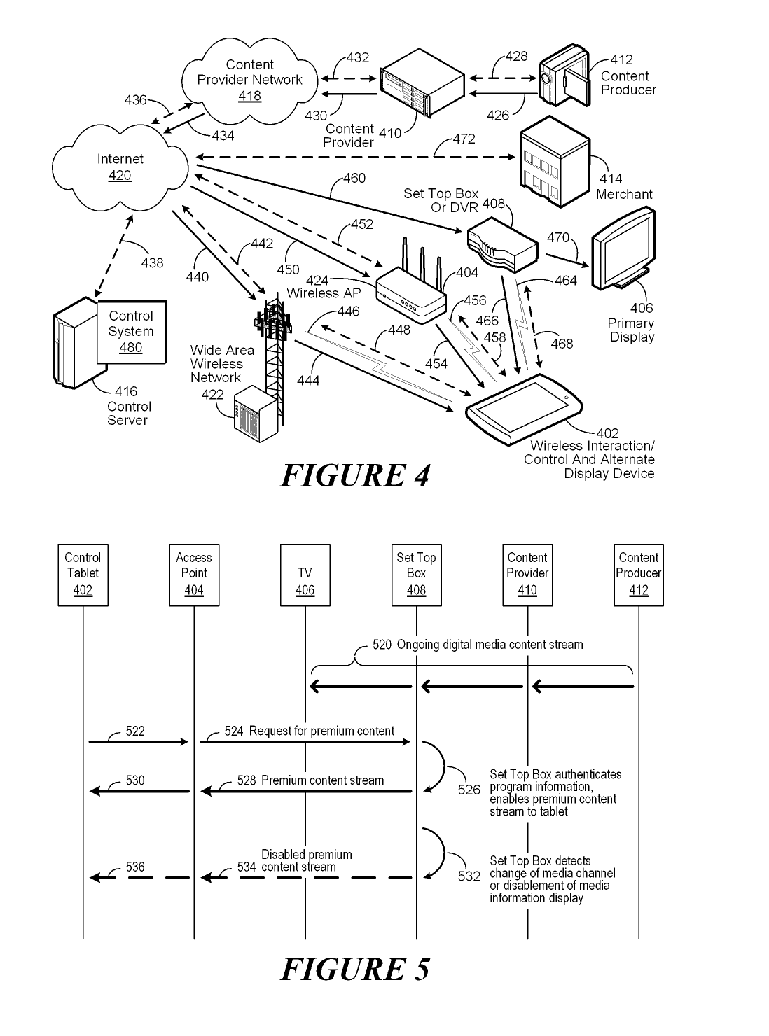

FIG. 4 is a simplified block diagram of a content management system as implemented in accordance with an embodiment of the invention. In this embodiment, a unidirectional media delivery plane (“delivery plane”) 426, 430, 434, 440, 444, 450, 460, 466, 470 is implemented with a bi-directional signaling plane (“signaling plane”) 428, 432, 436, 438, 442, 448, 452, 458, 468, 472 for managing the provision of a plurality of media content (“content”) through a corresponding plurality of networks and devices. In this embodiment and others, the content is provided and managed through a content provider network 418, a wired network, such as the Internet 420, a wide area wireless network 422, and various wireless connections 446, 456, 464.

As shown in FIG. 4, a content producer 412 delivers content to a content provider 410 over a delivery plane connection 426. In turn, the content provider provides the content over a delivery plane connection 430 to a content provider network 418, which likewise provides the content to the Internet 420 over a delivery plane connection 434. The content is then delivered over delivery plane connection 460 to a set top box (STB) or digital video recorder (DVR) 408 for display on a primary display 406, such as a television set. In various embodiments a plurality of content producers 412 deliver a plurality of content to a plurality of content providers 410, who in turn provide the content over a corresponding plurality of content provider networks 418, all of which are connected to the Internet 420. In these and other embodiments, the content may be combines, as in a mash-up familiar to those of skill in the art, for display on the primary display 406.

In various embodiments, a wireless interaction/control and alternative display device (“control tablet”) 402 is implemented to manage the provision of the aforementioned content. In these various embodiments, when the user brings the control tablet 402 in proximity to the primary display 406 or STB/DVR 408, the content is identified in various ways. For example, if a local wireless connection 464 exists between the STB/DVR 408 and control tablet 402, then the STB/DVR 408 may send metadata associated with the content and any associated or required control information to the control tablet 402.

Likewise, the control tablet 402 may capture a portion of the audio stream from the primary display 406. In turn, the control tablet 402 may send a quantized and encoded portion of the received audio stream to a media content control system (“control system”) 480 implemented on a control server 416. In various embodiments, the control tablet 402 may send the quantized or encoded information over a wireless connection 456 to the wireless access point (AP) 424 via a local wireless interface such as IEEE 802.11 WiFi, BlueTooth, Ultra-Wideband or other local interface, including a wired interface to the Internet 420. The control system 480 then identifies the content by detecting autocorrelation of the audio sample to a known sample, or alternatively, a correlation function related to the content's identity. Skilled practitioners of the art will realize that other signal processing methods may be used to identify the content and the foregoing is not intended to limit the spirit, scope, or spirit of the invention.

Accordingly, the content provider 412 can then make the content available to the user via a server function over signaling plane connections 428, 432, 436, 452, 458, 468 if the user enters an identifier such as a local cable channel number through an interface to the control tablet 402. In one embodiment, the STB/DVR 408 has a local wireless connection 464 to the control tablet 402, which it uses to send information associated with the aforementioned content. Once the content is recognized, a set of decisions may be made regarding the provision of premium content or promotional privileges to the consumer of the content.

For example, the producer or distributor of a television show can provide an incentive to audience members to continue to watch the program series by offering special premiums to the viewer, but only while the user is actively watching the show. Such premiums may include the provision of extra information such as sports highlights or behind-the-scenes views that would be sent to an alternative device, such as the control tablet 402, which is unrelated to the primary display 406. To further the example, other premiums may include discounts on sponsored products and other loyalty-related rewards based on the number of times that the viewer actually watched the program during the season or the number of related products that are purchased.

In one embodiment, the control tablet 402 autonomously detects the content type and sends periodic audio samples to the control system 480 and subsequently receives content identification data from the control system 480 in response. In another embodiment, the control tablet 402 receives content identification data from the control system 480, which it then uses to recognize the content. In these and other embodiments, the wireless control tablet 402 sends the content identification information to the control system 480 over an authenticated or non-authenticated channel, respectively using signaling plane connections 458, 452, 448, 442 via the local wireless AP 404 or the wide area wireless network 422.

If the control system 480 determines the validity of the content identification information, then it sends a request to the content provider 412, via signaling plane connections 438, 436, 432 with the address of the control tablet 402. In turn, the content provider 410 sends premium content to the control tablet 402 for display. Alternatively, the control system 480 uses a signaling plane connection 472 to establish a Private Virtual Circuit (PVC) between the control tablet 402 and a merchant node 414 to enable the purchase of goods and clearing of funds between a user and the merchant 414. However, if the control tablet 402 detects that the content is not being viewed or otherwise received from the primary display 406, then premium content, granted privileges, or both are canceled.

In one embodiment, the STB/DVR 408, using a wireless connection 464, receives a request from the control tablet 402 for premium content. In response, the STB/DVR 408 identifies the content it is sending to the primary display 406. The STB/DVR 408, having an ongoing reception of a stream of premium content available, decodes the premium content and sends it to the control tablet 402. If the STB/DVR 408 detects either a disabling of the reception of the content (e.g., changing channels or the STB/DVR 408 being powered down), or loss of control information from control tablet 402, then the set STB/DVR 408 terminates the transmission of premium content to the control tablet 402.

FIG. 5 is a generalized signal process flow as implemented in accordance with an embodiment of the invention for managing media content across multiple communication systems and related devices. In this embodiment, an ongoing media content stream (“content”) is provided from a content producer 412 to a content provider 410, and on to a set top box (STB) or digital video recorder (DVR) 408 for display on a primary display device (“TV”) 406. In this and other embodiments, a user of a wireless interaction/control and alternative display device (“control tablet”) 402 initiates a request 522 for premium content, which is communicated from the control tablet 402 to a wireless access point (AP) 404. In turn, the wireless AP 404 communicates 524 the request, as described in greater detail herein, to the STB/DVR 408.

The STB/DVR 408, as likewise described in greater detail herein, authenticates 524 information related to the content and enables a stream of premium content for communication to the control tablet 402. The premium content stream is then communicated 528 from the STB/DVR 408 to the wireless AP 404, where it is then further communicated 530 to the control tablet 402, where it is displayed. However, if the STB/DVR 408 detects 532 a change of channel in the TV 406, or other disablement of the TV 406 (e.g., the TV 406 is powered down), then the premium content is disabled 534 for conveyance to the wireless AP 402, and likewise further disabled 536 for conveyance to the control tablet 402, thereby preventing its display.

Although the described exemplary embodiments disclosed herein are described with reference to managing media content across multiple communication systems and related devices, the present invention is not necessarily limited to the example embodiments which illustrate inventive aspects of the present invention that are applicable to a wide variety of authentication algorithms. Thus, the particular embodiments disclosed above are illustrative only and should not be taken as limitations upon the present invention, as the invention may be modified and practiced in different but equivalent manners apparent to those skilled in the art having the benefit of the teachings herein. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

What is claimed is:

1. A client node, comprising:
processing logic, the processing logic used by the client node to:
detect a first media content stream being presented, the first media content stream provided to the display by a media content receiver:
generate and provide a content stream identification request message to the media content receiver:
receive content stream identification data from the media content receiver in response, the content stream identification data identifying the first media content stream:
generate and provide a content request message to a content control server node, the content request message comprising the content stream identification data: and
receive and display a second media content stream associated with the first media content stream.

2. The client node of claim 1, wherein the digital content media receiver comprises one of the set of:
a television:
a set top box (STB): and
a digital video recorder (DVR).

3. The client node of claim 1, wherein the client node discontinues the display of the second media content stream upon the discontinuation of the first media content stream being displayed on the display.

4. The client node of claim 1, wherein the client node is wirelessly connected to the media content receiver and the generation of the content request message initiates the establishment of a Private Virtual Circuit (PVC) between the media content receiver and a merchant, the PVC used by the client node to conduct a transaction with the merchant via the media content receiver.

5. The client node of claim 4, wherein the PVC is terminated upon discontinuation of the display of the first media content stream.

6. A method for managing media content, comprising:
using processing logic, the processing logic used by a client node to:
detect a first media content stream being presented, the first media content stream provided to the display by a media content receiver:
generate and provide a content stream identification request message to the media content receiver:
receive content stream identification data from the media content receiver in response, the content stream identification data identifying the first media content stream:
generate and provide a content request message to a content control server node, the content request message comprising the content stream identification data: and
receive and display a second media content stream associated with the first media content stream.

7. The method of claim 6, wherein the digital content media receiver comprises one of the set of:
a television:
a set top box (STB): and
a digital video recorder (DVR).

8. The method of claim 6, wherein the client node discontinues the display of the second media content stream upon the discontinuation of the first media content stream being displayed on the display.

9. The method of claim 6, wherein the client node is wirelessly connected to the media content receiver and the generation of the content request message initiates the establishment of a Private Virtual Circuit (PVC) between the media content receiver and a merchant, the PVC used by the client node to conduct a transaction with the merchant via the media content receiver.

10. The method of claim 6, wherein the PVC is terminated upon discontinuation of the display of the first media content stream.

11. A control server node, comprising:
processing logic, the processing logic used by the control server node to:
receive a content request message from a client node, the content request message comprising content stream identification data associated with a first media content stream; and
process the content stream identification data to generate a content delivery message comprising instructions to provide a second media content stream to the client node, the second media content stream provided to the client node by a content provider in response to the content provider receiving the content delivery message from the control server node.

12. The control server node of claim 11, wherein the second media content stream is associated with the first media content stream.

13. The control server node of claim 12, wherein the content stream identification data is processed by the control server node to determine the association between the first media content stream and the second media content stream.

14. The control server node of claim 11, wherein the control server node receives the content request message from the client node via a wireless connection through a wireless Local Area Network (WLAN) access point (AP).

15. The control server node of claim 11, wherein the control server node receives the content request message from the client node via a wireless connection through a wireless wide area network access point (AP).

16. A method for managing media content, comprising:
using processing logic, the processing logic used by a control server node to:
receive a content request message from a client node, the content request message comprising content stream identification data associated with a first media content stream; and
process the content stream identification data to generate a content delivery message comprising instructions to provide a second media content stream to the client node, the second media content stream provided to the client node by a content provider in response to the content provider receiving the content delivery message from the control server node.

17. The method of claim 16, wherein the second media content stream is associated with the first media content stream.

18. The method of claim 17, wherein the content stream identification data is processed by the control server node to determine the association between the first media content stream and the second media content stream:

19. The method of claim 16, wherein the control server node receives the content request message from the client node via a wireless connection through a wireless Local Area Network (WLAN) access point (AP).

20. The method of claim 16, wherein the control server node receives the content request message from the client node via a wireless connection through a wireless wide area network access point (AP).
